(19) United States
(12) Patent Application Publication
(10) Pub. No.: US 2009/0159658 A1
(43) Pub. Date: Jun. 25, 2009

(54) BARCODE REMOVAL

(75) Inventors: Eric Lap Min Cheung, Epping (AU); Andrew James Fields, Cremorne (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/329,971

(22) Filed: Dec. 8, 2008

(30) Foreign Application Priority Data
Dec. 21, 2007 (AU) 2007254619

(51) Int. Cl. G06F 19/00

(52) U.S. Cl. 235/375

(57) ABSTRACT

A method of removing a barcode from the bitmap representation of a document is disclosed. The barcode comprises a plurality of data encoding symbols (102) and (104). The method starts with the step of scanning said document containing the barcode to form the bitmap representation of the at least a portion of the document. From said bitmap representation, the plurality of data encoding symbols (102) and (104), defining said barcode, are identified and the barcode is decoded at least partially. The locations of data encoding symbols (102) and (104) in the bitmap representation of said document are then identified, using data obtained during the at least partial decoding of said barcode. Finally, at least some of the data encoding symbols (102) and (104) are removed from said bitmap representation of said document.

### CROSS-REFERENCE TO RELATED PATENT APPLICATIONS

This application claims the right of priority under 35 U.S.C. § 119 based on Australian Patent Application No. 2007254619, filed on 21 Dec. 2007, which is incorporated by reference herein in its entirety as if fully set forth herein.

### FIELD OF INVENTION

The current disclosure relates to a method for removing printed barcodes, and in particular to a method for identifying, locating and removing barcodes from the bitmap representation of a scanned page. The disclosure also relates to an apparatus and to a computer program product, including a computer readable medium having recorded thereon a computer program, for effecting the barcode removal.

### RELATED BACKGROUND ART

Many methods exist for discretely storing data on a printed document. One method includes printing a two-dimensional barcode onto the background of a document. Often, such a barcode is designed to have low visibility to minimise the reduction of readability in the document. Such barcodes typically store data using markings, such as dots or glyphs, which are sparsely arranged over the barcode region. These barcodes are printed on documents of a confidential or sensitive nature, and typically store a copy prevention code and/or tracking information. When the barcode is scanned by an appropriately equipped photocopier, the copy prevention code is extracted and used to determine whether copying should be allowed. Alternatively, when a leaked document is discovered, it is scanned and the tracking information is extracted and examined. The tracking information may contain useful forensic information related to the identity of the user who printed the document, and the time of the printing.

Conversely, there are special circumstances where the background barcode should be removed from a printed document when it is copied. For example, removing the protection from a copy prevented document requires barcode removal. Another application includes tracing the last user who has photocopied a marked document. This is achieved by detecting and removing the barcode from a document, during photocopying, embedding the user ID into a new barcode and reproducing the document with the new barcode at the background.

Several solutions exist for barcode removal. One method relies on the barcode markings being smaller than all other visual components of the document. An averaging or blurring filter is then applied to the scanned document to remove all marks of the size of the barcode markings. This method can result in significant loss of document image quality, and a limit on the maximum size of barcode markings. Another method relies on creating a document index for every printed document, placing original electronic copies of all documents on a server connected to the document index and storing a document index in the barcode of each document. Upon reproduction, the document index is extracted from the barcode, the corresponding electronic copy is retrieved from the server, and the electronic copy (which does not include the barcode) is printed out. While this gives the reproduced document excellent quality, storing electronic copies of all documents is an unwieldy solution and is, thus, rarely desirable.

### SUMMARY OF THE INVENTION

It is the object of the present disclosure to substantially overcome, or at least ameliorate, one or more disadvantages of existing arrangements, or to offer a viable alternative.

The described method offers a way of removing a barcode from a scanned image. A 2D dot-based low-visibility barcode is used.

The described method uses intermediate information from barcode decoding to help the barcode removal. This intermediate information allows accurate determination of the location of the barcode markings on the scanned bitmap. Accurate determination of mark locations allows removal with minimal damage to the background.

According to a first aspect of the present disclosure, there is provided a method for removing a barcode from a bitmap representation of document, said barcode comprising a plurality of data encoding symbols. The method comprises the steps of:
scanning at least a portion of said document including the barcode, to form a bitmap representation of the at least a portion of said document;
from said bitmap representation, identifying said plurality of data encoding symbols defining said barcode;
at least partially decoding said barcode;
identifying the locations of at least a portion of the data encoding symbols in the bitmap representation of said document, using data obtained during the at least partial decoding of said barcode; and
removing at least some of the data encoding symbols from said identified locations of the bitmap representation of said document.

According to a second aspect of the present disclosure, there is provided a computer program for facilitating the removal of a barcode from a bitmap representation of a document, said barcode comprising a plurality of data encoding symbols, said computer program comprising;
code means for facilitating scanning said document containing the barcode to form the bitmap representation of said document;
code means for facilitate, from said bitmap representation, identifying said plurality of data encoding symbols defining said barcode;
code means for at least partially decoding said barcode;
code means for identifying the locations of the data encoding symbols in the bitmap representation of said document, using data obtained during the at least partial decoding of said barcode; and
code means for removing the data encoding symbols from the bitmap representation of said document.

According to a third aspect of the present disclosure, there is provided a computer program product having a computer readable medium having a computer program recorded therein for of facilitating removing a barcode from a bitmap representation of a document, said barcode comprising a plurality of data encoding symbols, said computer program product comprising;
computer program code means for facilitating scanning said document containing the barcode to form the bitmap representation of said document;
computer program code means for, from said bitmap representation, identifying said plurality of data encoding symbols defining said barcode;
computer program code means for at least partially decoding said barcode;
computer program code means for identifying the locations of the data encoding symbols in the bitmap representation of said document, using data obtained during the at least partial decoding of said barcode; and
computer program code means for removing the data encoding symbols from the bitmap representation of said document.

According to a fourth aspect of the present disclosure, there is provided a method for conducting an audit trail of a document including a printed barcode. The method comprises the steps of;
removing a at least a portion of the barcode data from a bitmap representation of the document, the removal being effected according to the first aspect, or by way of the computer program of the second or the third aspect of the present disclosure;
creating a new barcode comprising data that is at least partially different from the removed data; and
printing the document with the new barcode in the background.

Other aspects of the present disclosure are also disclosed.

### BRIEF DESCRIPTION OF THE DRAWINGS

One or more embodiments of the disclosed method will now be described with reference to the following drawings, in which:

FIG. 1 shows a modulated grid of dots used for encoding data in the barcode;

FIG. 2 shows how the modulated grid of dots is viewed conceptually for decoding purposes;

FIG. 3 shows how data is encoded into the modulation of a single dot;

FIG. 4 is a detailed view of the encoding scheme used to encode data into the location modulation of a single dot;

FIG. 5 shows the decoding order of the data dots;

FIG. 6 shows the tiling scheme used for the barcode;

FIG. 7 is a schematic flow diagram of the stages in barcode decoding;

FIG. 8 is a diagram showing the output of the ‘grid navigation’ barcode decoding stage;

FIG. 9 is a diagram showing the output of the ‘region finding’ barcode decoding stage;

FIG. 10 is a diagram showing the output of the ‘tile aggregation’ barcode decoding stage;

FIG. 11 is a diagram showing the two outputs of ‘ECC decoding’ barcode decoding stage;

FIG. 12 is a schematic flow diagram of the steps in barcode removal;

FIG. 13 is a diagram showing tile reconstruction from two data channels;

FIG. 14 is a diagram showing interval array reconstruction from a tile;

FIG. 15 is a diagram showing how the interval array is mapped to the scanned image;

FIG. 16 is a diagram showing how the data dot locations are calculated;

FIG. 17 is a diagram showing how the alignment dot locations are calculated;

FIG. 18 is a diagram showing a simple technique to remove a dot from a scanned image;

FIG. 19 is a schematic flow diagram of the complete process of barcode scanning, decoding and removal; and

FIG. 20 is a schematic block diagram of a general purpose computer system upon which the arrangements described can be practiced.

### DESCRIPTION OF THE PREFERRED EMBODIMENTS

It is to be noted that any discussions contained in this specification that relate to prior art arrangements, refer to documents or devices which form public knowledge through their respective publication and/or use. Such discussions, however, should not be interpreted as a representation by the present inventor(s) or patent applicant that such documents or devices in any way form part of the common general knowledge in the art.

### Basic Structure

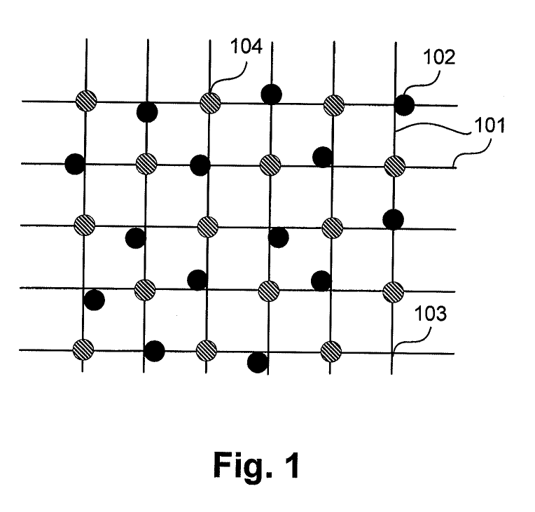

In the examples provided hereinafter, data is stored in the barcode using a modulated grid. FIG. 1 shows an enlarged view of the appearance of one embodiment of such a modulated grid. The illustrated modulated grid consists of a large number of encoding symbols, in the form of dots 102 and 104 that lie close to the intersection points 103 of a square grid 101. It should be noted that it is only the dots 102 and 104 that form the visible modulated grid. The lines forming grid 101 are shown only for the purpose of illustrating the locations of the dots 102 and 104.

The modulated grid in FIG. 1 consists of two types of dots. Dots such as 102 are offset from the intersection points 103, the direction of the offset defining the location modulation of each respective data dot 102. Since the positions of these dots are used for data encoding, this type of dots are also referred to as data-carrying dots (or data-carrying symbols). Dots 104 help establish a reference map for defining the locations of the data-carrying dots and, as such, represent an example of location-defining symbols (or location-defining dots). In this particular case, dots 104 lie exactly on intersection points 103 and are also referred to as alignment dots. Data dots and alignment dots are shown with different shading on FIG. 1, but the shading is only for illustrative purposes and they are usually identical except for their modulation. In the arrangement shown in FIG. 1, the barcode consists of 50% alignment dots and 50% data dots. Other arrangements are also possible.

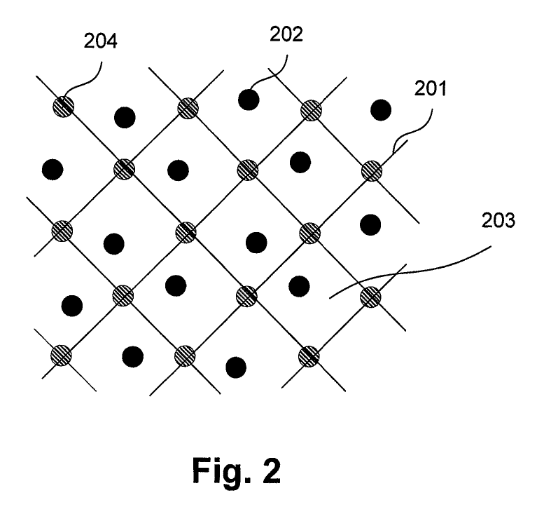

FIG. 2 shows the grid discovered from barcode decoding. In this figure, 201 is the discovered grid, 202 is a data dot and 204 is an alignment dot. The alignment dots 204 are used to define grid 201, and appear on each grid intersection point. Compared to grid 101, the alignment dots of grid 201 are located at every second intersection point. Accordingly, the discovered grid 201 is offset at 45 degrees and has a grid spacing that is a factor of \sqrt{2} larger than that of the original square grid 101. The discovered grid 201 divides the page into many square grid cells 203. Each grid cell 203 contains exactly one data dot 202. Grid cells are the basic unit used for barcode data storage, coding and decoding.

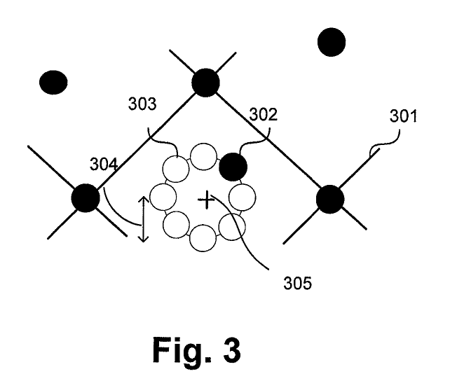

FIG. 3 shows how information is stored in the data dot in a grid cell. The dots 302 lie close to the grid cell centres 305 of the grid cells in grid 301, and each dot is modulated to one of eight possible positions 303. As seen in the figure, the eight possible positions are arranged in a circle centred on the relevant grid intersection. The eight modulation positions are offset from the grid centre horizontally, vertically or diagonally. The horizontal and vertical distance by which they are offset is the modulation quantum 304, herein abbreviated as “mq”. The modulation quantum mq is chosen to be a fixed percentage of the side length of the grid cell. A good choice for mq is 40% of the original square grid spacing.

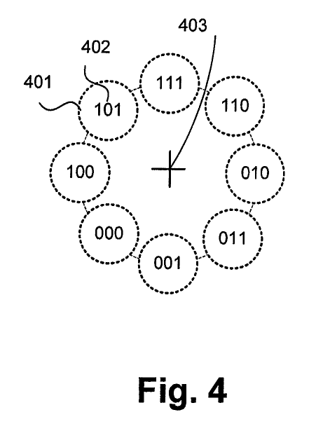

FIG. 4 shows the dot modulation positions 303 in greater detail. The positions are centred on the grid cell centre 403 and each modulation position 401 has a digital code value 402 associated with it. The eight modulation positions (including 401) allow each dot to encode one of eight possible digital code values (including the value 402 for position 401). This allows the grid of location-modulated dots to act as a digital data store, with each dot storing one base-eight digit of data. Ideally, each dot encodes a code value such that the dots are arranged in a Gray code in the circle. This facilitates error-correction during decoding. FIG. 4 shows the digital code value of each dot in binary. Thus, starting clockwise from 402, the dots encode the values: 5, 7, 6, 2, 3, 1, 0 and 4. Other modulation techniques could be used without departing from the scope of the disclosed method. For example, sixteen modulation positions could be used to encode sixteen possible digital code values.

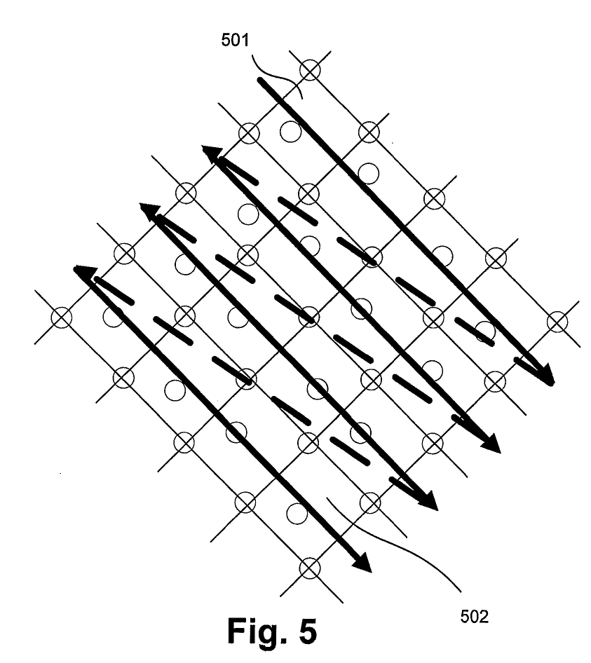

The preferred ordering of the digits of the digital data store is the ordering provided by using a rectangular array of dots, as shown in FIG. 5. This ordering starts at the topmost, leftmost grid cell 501 and proceeds left to right and then from top to bottom until the bottommost, rightmost grid cell 502 is reached. It is of course possible to use other orderings.

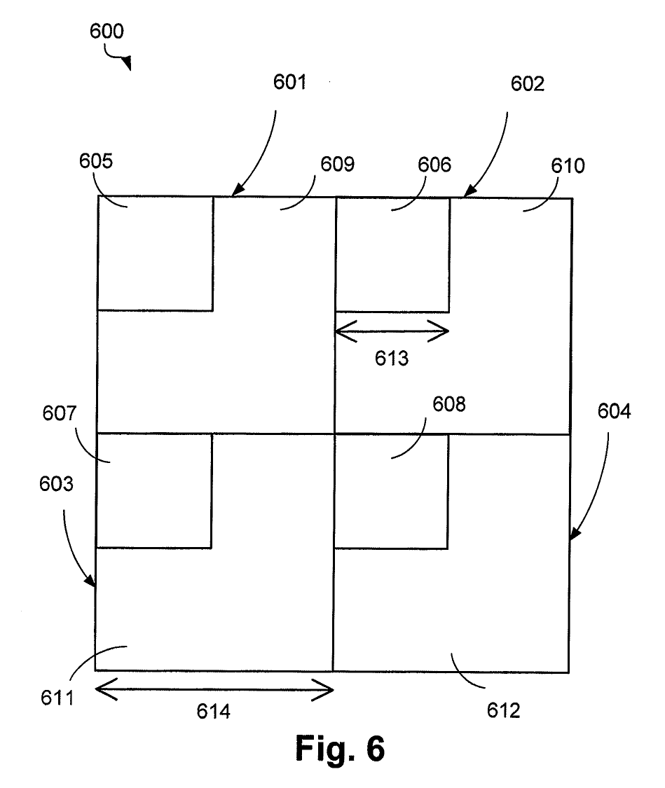

According to the described preferred embodiment, two informational channels of data are simultaneously stored in one barcode. Of course, this does not have to be the case and only a single channel, or more than two channels can be stored in the barcode. FIG. 6 shows the tiling arrangement used for a single unique tile 600 that includes the entire encoding data associated with the barcode. The barcode comprised in this single structural element is then repeatedly tiled over the entire grid for redundancy. Logically, each barcode tile represents the data from two separate data channels: a high data density (herein referred to as “HDD”) channel and a low data density (herein referred to as “LDD”) channel. The HDD channel has low robustness, while the LDD channel has high robustness. Spatially, the barcode tile 600 is composed of four sub-tiles 601, 602, 603 and 604, herein referred to as HDD channel tiles. The HDD channel tiles are square grids with dimensions of 614 (herein referred to as ‘HDD tile size’) in units of grid cells or data dots. Each HDD channel tile contains one smaller embedded tile, herein referred to as an LDD channel tile. The LDD channel tiles in the barcode tile 600 are 605, 606, 607 and 608. Each of these four LDD channel tile is a square grid with dimensions of 613 (herein referred to as ‘LDD tile size’), in units of grid cells or data dots, and is substantially identical to the other three tiles. Thus, the barcode tile 600 contains four copies of the LDD channel tile. On the other hand, areas 609, 610, 611 and 612 collectively make up the HDD channel. The HDD channel occupies the area of the four HDD channel tiles that is not occupied by the LDD channel tiles. Accordingly, the barcode tile 600 contains only a single copy of the HDD channel. The number of HDD channel tiles used to store the HDD channel can be expanded, as required. For example, arrangements of 3×3 or 4×4 HDD channel tiles are also possible. Notably, the discussed tiling scheme maintains a constant density of LDD channel tiles, independently of the HDD channel arrangement used, thus providing a highly redundant and robust LDD channel.

An error-correcting code (ECC) is applied to the data in both LDD and HDD channels. The preferred embodiment uses a low density parity check (LDPC) code, which is a high-performance ECC that is well known in the art.

### Barcode Removal

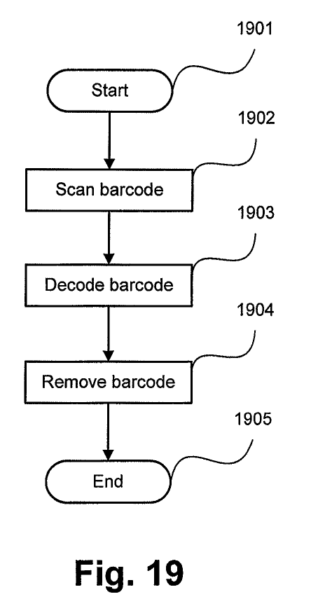

The complete process of barcode removal is shown in FIG. 19. The process starts at 1901.

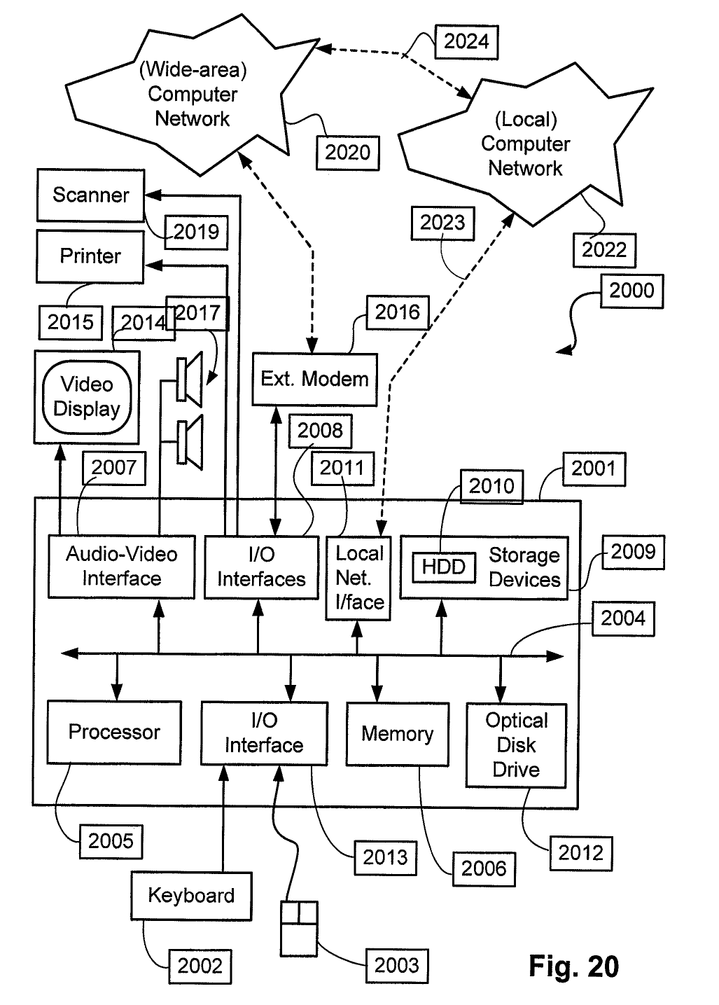

During the first stage 1902, the barcode printed on the paper sheet is converted into a digital scanned image, using an optical scanner 2019 shown in FIG. 20. If the printed encoding marks contain multiple barcodes, these are separated during the later decoding stages. The output of step 1902 is a scanned image, also referred to as a bitmap.

During the second stage 1903, the barcode in the scanned image is decoded and the embedded data is retrieved. This data, as well as other data from the intermediate stages of decoding, is used in the later stages to identify and remove the barcode. The output of step 1903 is the embedded data itself, as well as data from the intermediate decoding stages.

During the third stage 1904, the location of all the barcode markings is estimated, using the output from stage 1903. Each encoding symbol (marking) is then replaced with a predetermined two-dimensional shape, the colour of which is determined by a simple interpolation algorithm on the basis of the colour of the area in the vicinity of the respective symbol.

The process finishes at 1904, with the barcode being removed from the scanned image.

Stages 1903 and 1904 are described in more detail in the following sections entitled ‘Barcode decoding stages’ and ‘Barcode removal stages’, respectively.

### Barcode Decoding Stages

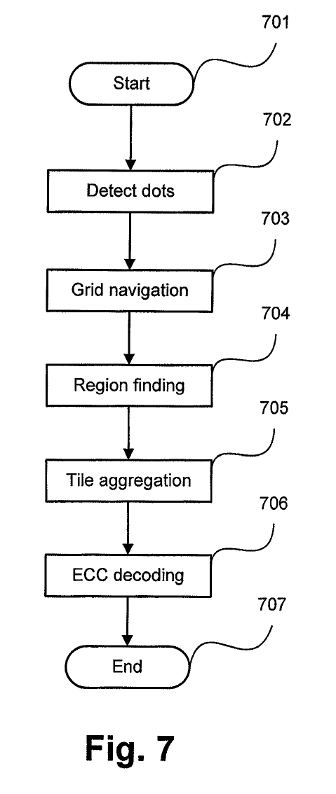

Accurately removing a barcode from a scanned document requires information from intermediate stages of barcode decoding. FIG. 7 shows the various stages in barcode decoding. Decoding starts at 701.

During the first operational stage 702, heuristics are used to locate all dots that appear like barcode dots in the scanned image. The output of 702 is a list of (x, y) pixel coordinates of the centre of mass of each located dot.

During the second stage 703, a priority-based flood-fill algorithm is used to fit suitable grids over the locations of located dots. In the typical case the output of 703 will be a single grid that covers the entire scanned image. In special cases, multiple grids of different spacing and orientation will be found covering the scanned image. For example, if the scanned image contains two or more barcodes that are disjoint, have different spacing or different orientations, a separate grid will be output for each barcode detected.

During the third stage 704, each grid identified in stage 703 is divided into separate regions based on data similarity, using a segmentation algorithm. Typically, the output for 704 is a single region defining a basis structural cell covering the grid. In special cases, multiple regions can be found. For example, if the grid contains two barcodes that were not successfully separated during the stage 703, at this stage they will be correctly separated into two regions. Accordingly, the output from this stage will be two identified regions.

During the fourth stage 705, the data of the repeated tiles in each region is processed to define a single tile. The dimensions of the sub-tiles are found by way of autocorrelation of the data of a number of tiles. In FIG. 6, the dimensions of the sub-tiles 601-604 are 2×2. Thus, the tiles in the identified region are summed into a single tile. This aggregated tile is the output of 705.

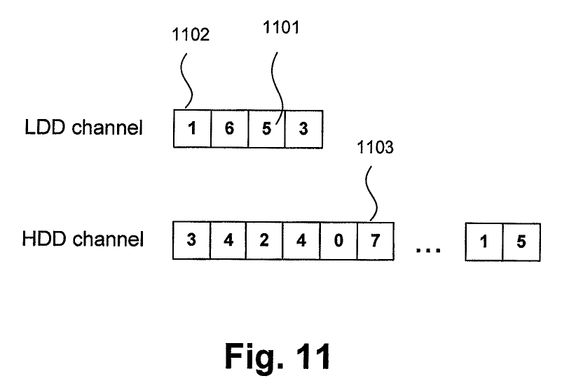

During the fifth stage 706, the aggregated tile is serialised into LDD and HDD channels, any errors are corrected, using the error correcting code, and the barcode is decoded. The output of 706 is the LDD data sequence 1102 and HDD data sequence 1103 illustrated in FIG. 11. The process finishes at 707.

It should be noted that in the present disclosure the term “decoding” refers to the process resulting in the extraction of the binary data sequences shown in FIG. 11 from the encoding symbols of the bitmap obtained from a printed page. More strict interpretations may require the term “decoding” to also include the step of extracting the user related information that is encoded in the binary data sequence in FIG. 11. In this case, the above described process that ends with the extraction of the binary sequence, should be considered to be a partial decoding of the barcode.

The process of barcode removal requires intermediate information from the grid navigation stage 703, the region finding stage 704, the tile aggregation stage 705 and the ECC-decoding stage 706. Each of these stages is described in more detail in the following text.

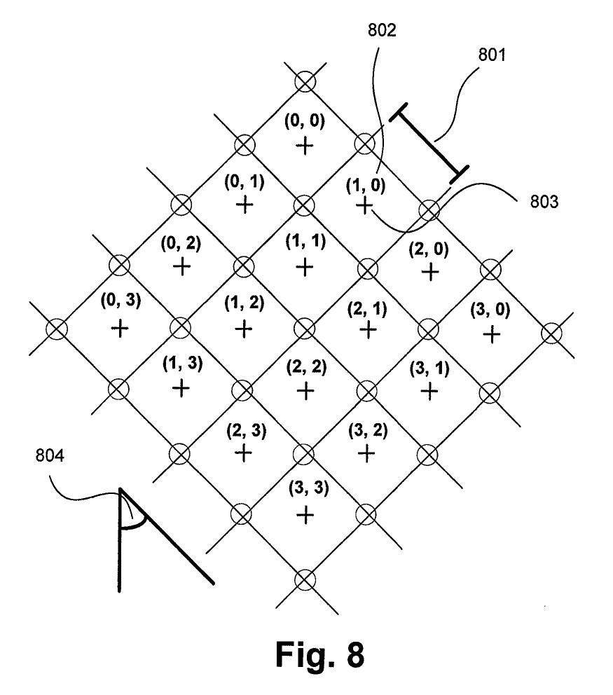

FIG. 8 shows three important grid properties that are calculated during ‘grid navigation’ stage 703. The side length 801 of each grid cell is hereinafter referred to as the ‘grid spacing’. From the grid spacing the modulation quantum mq is computed, as it is a fixed percentage of the grid spacing. The logical row/column coordinates of each grid cell are denoted with 802. These coordinates start from (0, 0) in the upper-left grid cell and are sequentially numbered by column and by row, according to the decoding order shown in FIG. 5. Hereinafter these coordinates will be referred to as ‘logical coordinates’. The centre of each grid cell is denoted with 803. Each centre has coordinates (x, y), not shown, that represent pixel locations in the scanned image. Each pair of coordinates has a corresponding pair of logical coordinates, and will be referred to hereafter as ‘centre coordinates’. The angle 804, that each grid cell makes from the vertical, is hereafter referred to as ‘grid angle’.

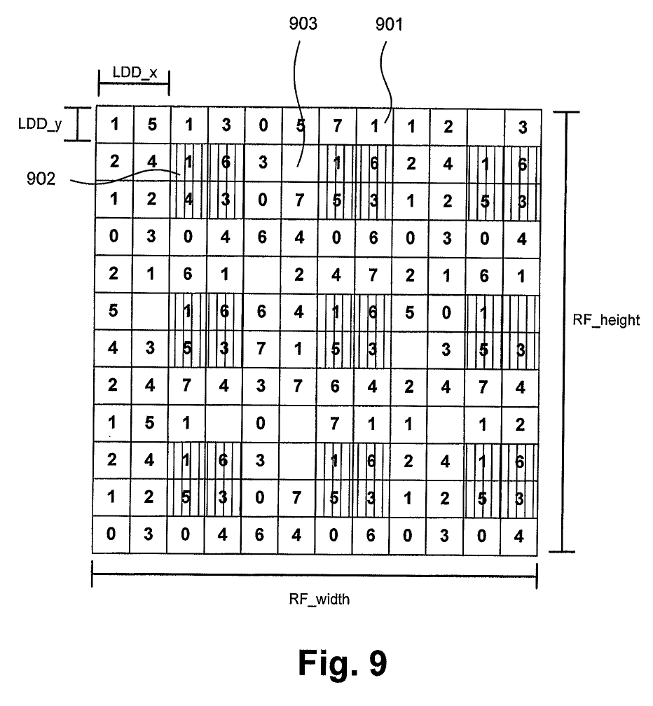

FIG. 9 shows the output of the ‘region finding’ stage 704, which is a 2D array of 3-bit numbers 901 called ‘intervals’. Every grid cell from ‘grid navigation’ is mapped to an interval in the array via its logical coordinate. The value of the interval is calculated as follows. Firstly, the location of the data dot in the grid cell is found. Then the vector from the centre coordinate to the data dot, called the ‘offset’, is calculated. Lastly, the offset is converted to a 3-bit number according to the modulation scheme shown in FIG. 4. Since data dots can be missing or incorrectly detected from grid cells, blank or incorrect intervals 903 may exist in the array.

In FIG. 9 the LDD tiles 902 are shown shaded. The LDD tile size is 2 and the LDD tile step size is 4. (LDD_x, LDD_y), hereafter referred to as the ‘LDD offset’, is the displacement of the upper-left most LDD tile from the top left corner. The LDD offset is important for barcode removal, since it identifies the location of all the LDD tiles (LDD tiles repeat in fixed intervals). The size of the 2D array is known and referred to as (RF_width, RF_height).

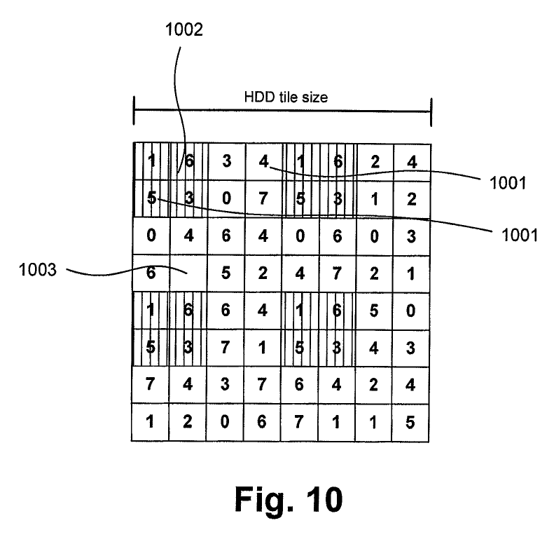

FIG. 10 shows the output of the ‘tile aggregation’ stage 705, which is an ‘aggregated tile’. The size of the aggregated tile in FIG. 10, also referred to as ‘HDD tile size’, is 8 by 8. Each aggregated tile contains 4 LDD tiles. The aggregated tile consists of ‘aggregated intervals’ 1001. Aggregated intervals are 3-bit numbers calculated by considering the data in all repeating tiles in the barcode, finding all the intervals corresponding to this tile location and taking the most frequently occurring interval. LDD tiles 1002 are shown shaded. Even after aggregating the repeating tiles, aggregated intervals may still be incorrect or missing, the missing aggregated interval 1003 being such an example.

FIG. 11 shows the results of ECC decoding stage 707. Interval 1101 is a ‘corrected interval’ This is an aggregated interval that has been passed through the error correcting code decoder and the errors of which have consequently being repaired. Binary sequence 1102 is the recovered LDD data channel, which includes the serialised data of the LDD tiles in the aggregated tile. Similarly, binary sequence 1103 is the recovered HDD data channel, which includes the serialised data of non-LDD tiles in the aggregated tile.

### Barcode Removal Stages

Before removal the barcode must be successfully decoded and the intermediate decoding data, mentioned hereinbefore, must be available.

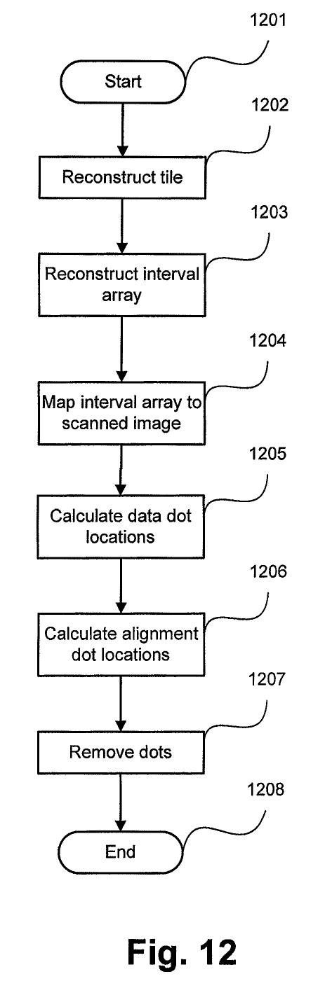

FIG. 12 is a high-level view of the barcode removal process. Removal starts at 1201.

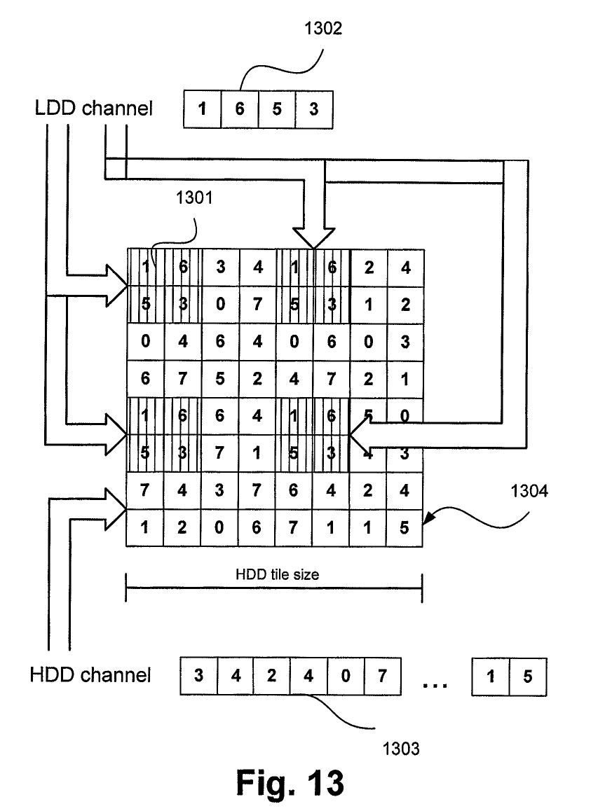

During the first stage 1202, the LDD and HDD data channels are arranged into a single tile. FIG. 13 shows this stage in detail. The reconstructed tile 1304 starts off with empty intervals. Firstly, using the HDD tile size, the location of each LDD tile 1301 is computed. In this example, the HDD tile size is 8 and the LDD tile step size is 4, so there will be 4 LDD tiles distributed in the arrangement shown. Secondly, the intervals in each LDD tile are copied from the intervals in the LDD data channel 1302 from top to bottom and left to right, that is, in raster order. Thirdly, the remaining empty intervals in 1304, which are not part of an LDD tile, are copied from the HDD data channel 1303 in raster order. The output of 1202 is the reconstructed tile.

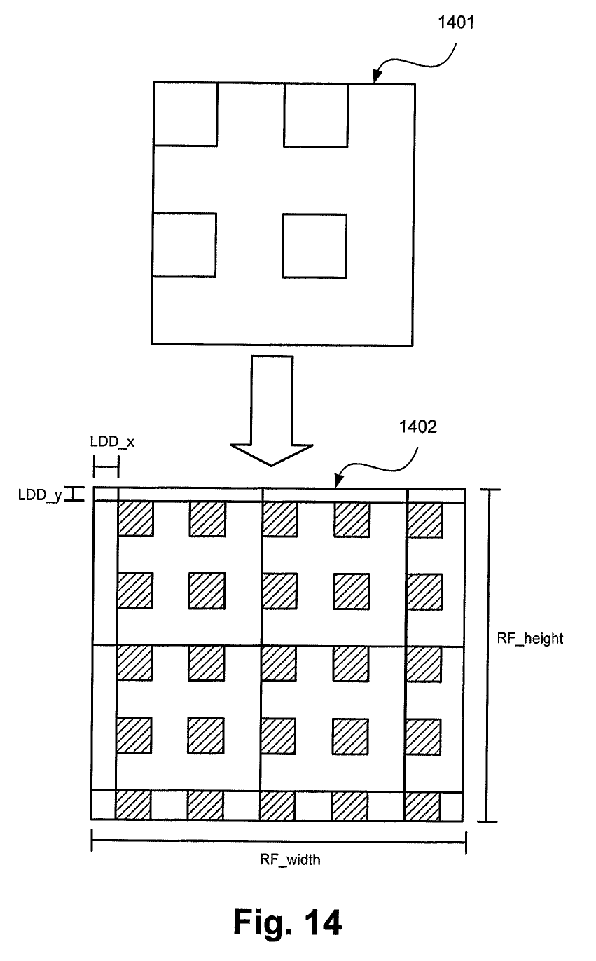

The second stage 1203 duplicates the reconstructed tile over an interval array. FIG. 14 shows this stage in detail. The single tile 1401 is duplicated over a 2D interval array 1402. Firstly, a 2D interval array is created of size (RF_width, RF_height). Secondly, the intervals in the single tile are copied over, with the first tile placed at the LDD offset (LDD_x, LDD_Y) and the other tiles tessellated regularly over the array 1402, as shown, until the entire array is filled. The output of 1203 is the reconstructed interval array.

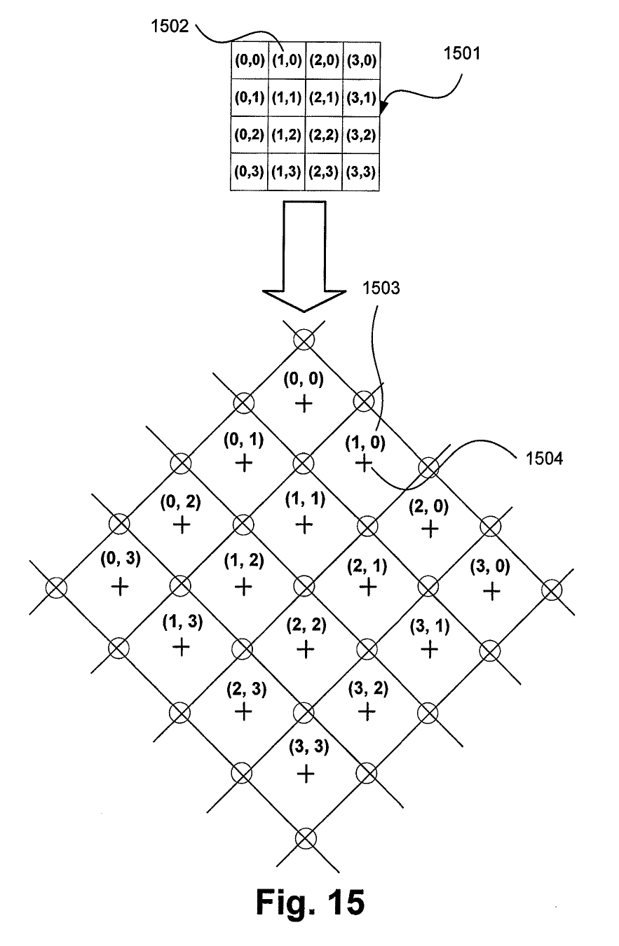

The third stage 1204 maps each interval in the reconstructed interval array to its approximate location on the scanned image. FIG. 15 shows this process in detail. Every interval in array 1501 has corresponding logical coordinates, which represent the interval's row and column locations. With reference to interval 1502 that has logical coordinates (1, 0), the mapping process proceeds as follows. Information is retrieved for the grid cell 1503 that has logical coordinates (1, 0). In particular, the coordinates of centre 1504 are retrieved. Here it should be recalled that the centre coordinates identify the location of the centre of the grid cell on the scanned image. The process is applied to all the intervals in the array. The output of 1204 is the centre coordinates of every interval in the interval array in the bitmap of the scanned image.

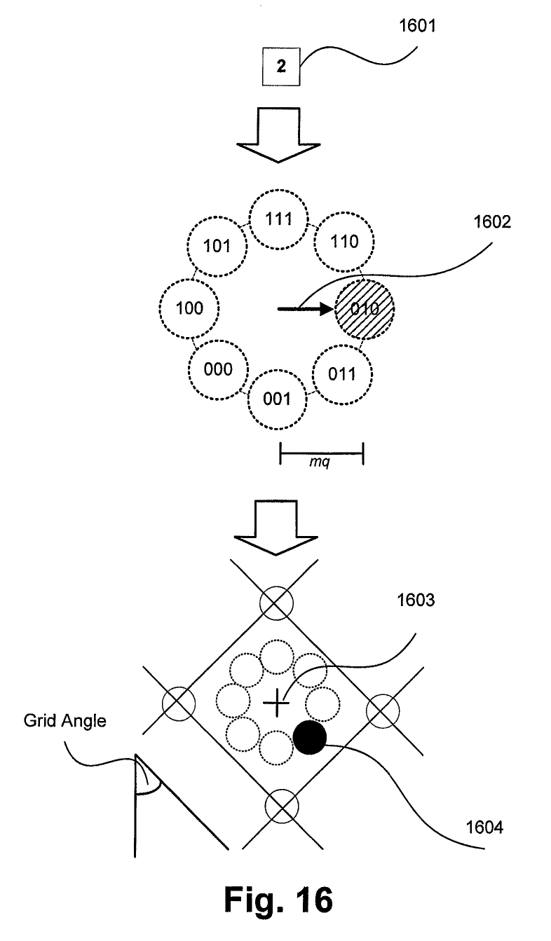

The fourth stage 1205 determines where each data dot is located on the scanned image. FIG. 16 shows this process in detail. Interval 1601 is converted to an offset vector 1602, according to the encoding scheme in FIG. 4. The direction of the vector is determined by the value of the interval and the length is the modulation quantum mq. Next, the offset vector is rotated by the grid angle and added to the interval centre coordinate 1603, to find the dot position 1604 on the scan. The output of 1205 is a list of data dot positions with one for every interval in the interval array.

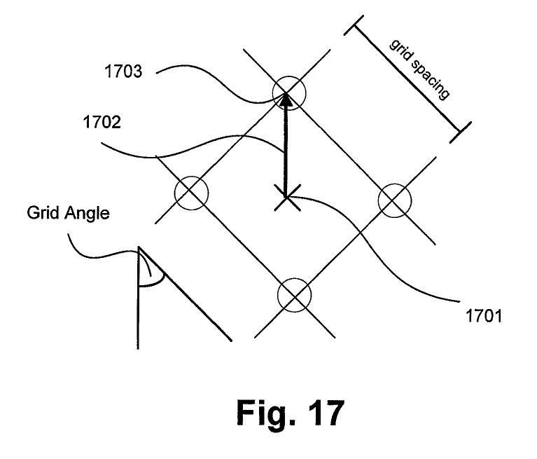

The fifth stage 1206 determines where each alignment dot is located on the scanned image. Each grid cell is processed according to FIG. 17. An offset vector 1702 is created from the grid angle and grid spacing. This is added to the grid cells centre coordinate 1701 to obtain the alignment dot position 1703. The output of 1206 is a list of alignment dot positions, one position for every grid cell.

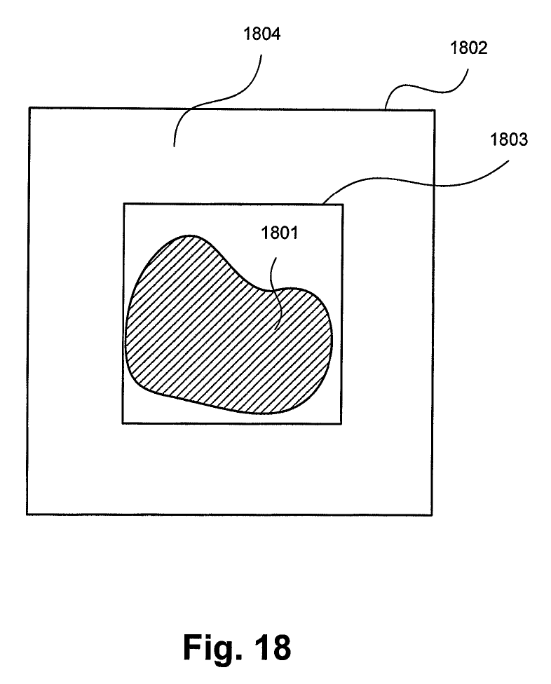

The sixth stage 1207 generates a new bitmap in which all barcode dots are removed. FIG. 18 shows the removal technique in detail. Firstly, the data dot list from stage 1205 and the alignment dot list from stage 1206 are combined into a single list of dot positions. For every dot 1801 two concentric squares 1803 and 1802 are defined. Each square has a fixed size that is determined experimentally. Examples for suitable sizes are 4 pixels, for 1803, and 10 pixels, for 1802. Next, the average pixel value of the pixels in the area between the two concentric squares 1804 is calculated. Finally, 1803 is filled with the calculated average pixel value, erasing the dot from the scanned image with minimal background disturbance. The process finishes at 1208, with the barcode being removed from the scanned image. Of course, depending on the application, the step of modifying the bitmap of the scanned document may be performed not on the original, but on a copy of the original bitmap representation, thus preserving the original bitmap representation for archiving purposes.

### Variations

The dot removal stage 1207 in FIG. 12 uses a basic interpolation algorithm to remove a dot from the scanned image. Many more sophisticated reconstruction algorithms exist in the art, and they can be freely substituted for the basic version described here.

In addition, the barcode removal process in FIG. 12 requires the extraction of both the LDD and HDD channels from the barcode. However, often only the robust LDD channel can be retrieved from a damaged barcode, so barcode removal cannot be performed with the normal technique. There are still some special cases where this barcode can still be removed. If reference data (in particular, the contents of the HDD channel) is available from the stage of creation of the barcode, such data can be used with the decoded LDD channel to reconstruct the aggregated tile in step 1202. The rest of the process is performed in the usual manner, allowing the barcode to be successfully removed.

### Hadrware Implementetion

The method for identifying, locating and removing barcodes from a scanned pages may be implemented using a computer system 2000, shown in FIG. 20, wherein the steps illustrated in FIGS. 7, 12 and 19 may be implemented by way of one or more application programs executable within the computer system 2000. In particular, the various steps of the method for identifying, locating and removing barcodes from a scanned page are effected by software instructions carried out within the computer system 2000. The instructions may be formed as one or more code modules, each for performing one or more particular tasks. The software may also be divided into two separate parts, in which a first part and the corresponding code modules performs the described method and a second part and the corresponding code modules manage a user interface between the first part and the user. The software may be stored in a computer readable medium, including the storage devices described below, for example. The software is loaded into the computer system 2000 from the computer readable medium, and then executed by the computer system 2000. A computer readable medium having such software or computer program recorded on it is a computer program product. The use of the computer program product in the computer system 2000 preferably effects the hereinbefore described advantageous method for identifying, locating and removing barcodes from a scanned page.

As seen in FIG. 20, the computer system 2000 is formed by a computer module 2001, input devices such as a keyboard 2002 and a mouse pointer device 2003, and output devices including a printer 2015, scanner 2019, a display device 2014 and loudspeakers 2017. An external Modulator-Demodulator (Modem) transceiver device 2016 may be used by the computer module 2001 for communicating to and from a communications network 2020 via a connection 2021. The network 2020 may be a wide-area network (WAN), such as the Internet or a private WAN. Where the connection 2021 is a telephone line, the modem 2016 may be a traditional “dial-up” modem. Alternatively, where the connection 2021 is a high capacity (eg: cable) connection, the modem 2016 may be a broadband modem. A wireless modem may also be used for wireless connection to the network 2020.

The computer module 2001 typically includes at least one processor unit 2005, and a memory unit 2006 for example formed from semiconductor random access memory (RAM) and read only memory (ROM). The module 2001 also includes an number of input/output (I/O) interfaces including an audio-video interface 2007 that couples to the video display 2014 and loudspeakers 2017, an I/O interface 2013 for the keyboard 2002 and mouse 2003 and optionally a joystick (not illustrated), and an interface 2008 for the external modem 2016 and printer 2015. In some implementations, the modem 2016 may be incorporated within the computer module 2001, for example within the interface 2008. The computer module 2001 also has a local network interface 2011 which, via a connection 2023, permits coupling of the computer system 2000 to a local computer network 2022, known as a Local Area Network (LAN). As also illustrated, the local network 2022 may also couple to the wide network 2020 via a connection 2024, which would typically include a so-called “firewall” device or similar functionality. The interface 2011 may be formed by an Ethernet™ circuit card, a wireless Bluetooth™ or an IEEE 802.11 wireless arrangement.

The interfaces 2008 and 2013 may afford both serial and parallel connectivity, the former typically being implemented according to the Universal Serial Bus (USB) standards and having corresponding USB connectors (not illustrated). Storage devices 2009 are provided and typically include a hard disk drive (HDD) 2010. Other devices such as a floppy disk drive and a magnetic tape drive (not illustrated) may also be used. An optical disk drive 2012 is typically provided to act as a non-volatile source of data. Portable memory devices, such optical disks (eg: CD-ROM, DVD), USB-RAM, and floppy disks for example may then be used as appropriate sources of data to the system 2000.

The components 2005, to 2013 of the computer module 2001 typically communicate via an interconnected bus 2004 and in a manner which results in a conventional mode of operation of the computer system 2000 known to those in the relevant art. Examples of computers on which the described arrangements can be practised include IBM-PC's and compatibles, Sun Sparcstations, Apple Mac™ or alike computer systems evolved therefrom.

Typically, the application programs for implementing the discussed method for barcode removal are resident on the hard disk drive 2010 and read and controlled in execution by the processor 2005. Intermediate storage of such programs and any data fetched from the networks 2020 and 2022 may be accomplished using the semiconductor memory 2006, possibly in concert with the hard disk drive 2010. In some instances, the application programs may be supplied to the user encoded on one or more CD-ROM and read via the corresponding drive 2012, or alternatively may be read by the user from the networks 2020 or 2022. Still further, the software can also be loaded into the computer system 2000 from other computer readable media. Computer readable storage media refers to any storage medium that participates in providing instructions and/or data to the computer system 2000 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 2001. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces (GUIs) to be rendered or otherwise represented upon the display 2014. Through manipulation of the keyboard 2002 and the mouse 2003, a user of the computer system 2000 and the application may manipulate the interface to provide controlling commands and/or input to the applications associated with the GUI(s).

The method for identifying, locating and removing barcodes from a scanned document may alternatively be implemented in dedicated hardware module that may include graphic processors, digital signal processors, or one or more microprocessors and associated memories.

The foregoing describes only some embodiments of the disclosed method, and modifications and/or changes can be made thereto without departing from the scope and spirit of the method, the embodiments being illustrative and not restrictive.

For example, the dot removal method described hereinbefore is directed to a barcode that uses a mixture of 50% alignment dots and 50% data dots. The ratio between the location-defining symbols, in the form of location-defining dots, and the data-carrying symbols, such as the data carrying dots, can be changed. In the extreme case, the alignment dots can be removed altogether. In such a barcode every dot is a data dot that is offset from an intersection point on a virtual grid. Decoding a barcode without alignment dots can be performed with additional computational expense. One simple method works as follows. Firstly, the location of the present dots is detected. Secondly, the angle and spacing of the virtual grid is estimated by statistical methods. A histogram of the number of dots in each row and a histogram of the number of dots in each column are then created and the peaks are found in both histograms, which indicate the location of each horizontal line and vertical line in the virtual grid. Finally, data dots are read from the virtual grid, according to each line, as previously described. Thus, it is envisaged that the hereinbefore described method for dot removal will work with a barcode containing any ratio of alignment/data dots, including 0%.

The data encoding symbols do not have to be dots and could be in the form of bars or any other predetermined shape. Their deletion will similarly be effected by identifying the locations of their central points and using concentric squares, or other shapes of respective dimensions that depend on their shape and size of the encoding symbols. Different location-related encoding configurations can also be used.

In addition, because of the principal of redundancy applied in such encoding/decoding applications, the execution of the hereinbefore described method is not necessarily associated with obtaining the encoding data printed over the entire document. As described in relation to FIGS. 6 and 9, according to the preferred encoding arrangement, the complete set of the encoding data is included in a single tile 600, which is then repeatedly overlayed to cover the entire page of the printed document. Accordingly, scanning even a small portion of the document may be able to provide the necessary information for the application of the method, as long as the scanned area includes at least one tile 600. Similarly, once the entire document, or only a portion of it, is scanned, not all of the obtained data has to be processed, as long as the processed amount of data includes the data from at least one tile 601.

In addition, while the forgoing description was directed to an application involving the deletion of the entire, or almost entire, barcode from the page, even the deletion of some of the encoding symbols of the barcode may be sufficient for other applications. For example, an application may be envisaged, in which only the data carrying points 102 are deleted, while the data location points 104 are left in the document to facilitated the application of a new barcode including a different set of data carrying points.

Finally, as was mentioned in the forgoing text, while in this specification the step of “decoding” the barcode was assumed to conclude with the extraction of the binary codes illustrated in FIG. 11, in order to accommodate more strict interpretations of the expression “decode”, which encompass the additional step of extracting the user-related information out of the binary sequence of FIG. 11, the process of “decoding”, which ends with the extraction of these binary sequences, will also be referred to as “at least partially decoding”.

### INDUSTRIAL APPLICABILITY

A typical application of the barcode removal technology is related to maintaining an audit trail for a printed document. This is done by storing a user ID list in a barcode on the printed document. When the document is printed, the barcode contains a user ID list including the user ID of the person effecting the printing. When such a printed document is photocopied, the user ID list is decoded and the barcode is removed. The user ID of the photocopier operator is then appended to the ID list, a new barcode is created with the new ID list and the new barcode is embedded on the photocopied document. When a leaked document is discovered, an audit trail can be created by decoding the ID list from the barcode. This list is a history trail of all the users who have copied this document since its creation. In other embodiments, when a subsequent user processes the document, the ID of the previous user is not removed, but is instead kept in the ID list, to which the ID of the new user is also added.

Two or more barcodes can be used simultaneously on a security document to provide multiple levels of protection. Typically, one barcode is sparse with high robustness and low data capacity, and the other barcode is dense, with low robustness and high data capacity. The barcodes may use different data encoding schemes. The sparse barcode may store, for example, the serial number of the printer, and the dense barcode may store, for example, an audit trail. The dense barcode typically includes a much larger number of encoding symbols than the sparse barcode. Accordingly, while the decoding of the dense barcode may be relatively easy, the decoding the sparse barcode is often difficult. In a document including such a combination of barcodes, the method described in this specification can firstly be applied to decode and remove the dense barcode. As the hereinbefore described method for barcode removal is accurate, the sparse barcode markings will be substantially unaffected by this removal. Finally, as the sparse barcode is now exposed, it can be decoded much easier by using standard barcode decoding techniques.

It is apparent from the above that the described arrangements are applicable to any industries associated with secure data processing and office administration.

1. A method of removing at least a portion of a barcode from a bitmap representation of a document, said barcode comprising a plurality of data encoding symbols, the method comprising the steps of:
a) scanning at least a portion of said document including the barcode, to form a bitmap representation of the at least a portion of said document;
b) from said bitmap representation, identifying said plurality of data encoding symbols defining said barcode;
c) at least partially decoding said barcode;
d) identifying the locations of at least a portion of the data encoding symbols in the bitmap representation of said document, using data obtained during the at least partial decoding of said barcode; and
e) removing at least some of the data encoding symbols from said identified locations of the bitmap representation of said document.

2. A method according to claim 1 wherein the barcode comprises at least one grid, the grid being defined by location-defining symbols and data-carrying symbols.

3. A method according to claim 2 wherein the barcode comprises location-defining dots and data-carrying dots.

4. A method according to claim 3, wherein the barcode comprises a plurality of identical tiles, each tile comprising one or more informational channels.

5. A method according to claim 4, wherein the at least partial decoding of said barcode comprises;
detecting the dots defining said barcode;
identifying a grid structure defined by at least some of the detected dots;
identifying a single structural tile of the identified grid structure;
processing at least some of the data encoded by the data encoding symbols within a first identified single structural tile; and
performing error-correction on the basis of data encoded by the data encoding symbols within at least a second identified single structural tile.

6. A method according to claim 5 wherein identifying the locations of at least a portion of the data encoding symbols in the bitmap representation of said document comprises;
reconstruction of the single structural tile;
reconstruction of the grid structure;
mapping of an interval array to a scanned image; and
calculating locations of said data encoding symbols.

7. A method according to claim 1 wherein removing at least some of the data encoding symbols comprises modifying the bitmap of said document, wherein the area of each of said data encoding symbols to be removed is replaced with a deleting mark, the pixel value of the area of said deleting mark being defined on the basis of the pixel value of the bitmap area in the vicinity of said removed data encoding symbol, by way of an interpolation algorithm.

8. A method according to claim 1 wherein reference data from creation of the barcode is used to facilitate removing at least some of the data encoding symbols from said identified locations of the bitmap representation of said document, when the scanned barcode cannot be extracted.

9. A method according to claim 1, wherein a second barcode exists on the scanned document and decoding of said second barcode is facilitated by the removal of the encoding symbols of the first barcode.

10. A method according to claim 1, wherein;
the entire said document, containing the barcode, is scanned so as to form a bitmap representation of said document;
the locations of said data encoding symbols are identified in the bitmap representation of said document; and
the data encoding symbols are removed from the bitmap representation of said document.

11. A computer readable storage medium having a computer program recorded thereon, the program being executable by a computer apparatus to make the computer remove a barcode from a bitmap representation of a document, said barcode comprising a plurality of data encoding symbols, said program comprising;
code for facilitating scanning said document containing the barcode to form the bitmap representation of said document;
code for facilitating, from said bitmap representation, identifying said plurality of data encoding symbols defining said barcode;
code for at least partially decoding said barcode;
code for identifying the locations of the data encoding symbols in the bitmap representation of said document, using data obtained during the at least partial decoding of said barcode; and
code for removing the data encoding symbols from the bitmap representation of said document.

12. A method for maintaining an audit trail of a document including a printed barcode, the method comprising the steps of;
removing at least a portion of a barcode data from the document, the removal being effected according to the method of claim 1;
creating a new barcode comprising encoding data that is at least partially different from the removed encoding data; and
printing a copy of the document with the new barcode in the background.
